(19) United States
(12) Patent Application Publication
(10) Pub. No.: US 2014/0152564 A1
(43) Pub. Date: Jun. 5, 2014

(54) PRESENTATION SELECTION BY DEVICE ORIENTATION

(71) Applicant: Viscira, LLC, San Francisco, CA (US)

(72) Inventors: David Gulezian, San Francisco, CA (US); Richard Turner Barker, Piedmont, CA (US); Nathaniel Anthony Fast, Santa Rosa, CA (US); Rodwin Pabello, San Francisco, CA (US)

(73) Assignee: Viscira, LLC, San Francisco, CA (US)

(21) Appl. No.: 14/094,638

(22) Filed: Dec. 2, 2013

Related U.S. Application Data
(60) Provisional application No. 61/797,434, filed on Dec. 5, 2012.

(51) Int. Cl. G06F 3/0346

(52) U.S. Cl. CPC G06F 3/0346
USPC 345/158

(57) ABSTRACT

A technique involves providing multiple different presentations on a mobile device, and switching between the different presentations depending upon the orientation of the mobile device. For example, a first presentation could include a scripted action, which may include recorded speech or used concurrently with a speaker, and a second presentation that enables free play within a model. When the mobile device is held in a first orientation, the scripted action is used to present a pitch, lesson, or the like. When the mobile device is held in a second orientation, the free play enables a user of the mobile device to illustrate reactions within a model by way of example or in response to questions that can most effectively be answered within a model.

### CROSS-REFERENCE TO RELATED APPLICATIONS

This application claims priority to U.S. Provisional Patent Application No. 61/797,434, filed Dec. 5, 2012, entitled “PRESENTATION SELECTION BY DEVICE ORIENTATION,” which is incorporated by reference.

### BACKGROUND

Detailing in the pharmaceutical industry is a typically 2 to 5 minute explanation of a drug. Traditionally, detailing was accomplished using a printed brochure. Today, mobile devices, such as tablet computers, are replacing the traditional printed brochure to enable more dynamic explanations. The older print technologies are not as eye-catching as the newer electronic technologies. The newer technologies also enable a greater degree of interactivity with the material that is being presented.

Detailing is but one example of possible uses of mobile devices utilizing the electronic technologies. Similar techniques can be used in a variety of business settings, such as to pitch an idea, education settings, such as to teach a concept, or the like. Depending upon an area of improvement in the newer electronic technologies, some or all of these and other social interactions can conceivably be made more effective in a manner that will vary depending upon the nature of the improvement.

Making the newer technologies more useful and effective is an area of ongoing research and development. Any advancement that resulted in greater utility, flexibility, effectiveness, or other improvement would likely be of interest to at least some individuals in the field.

### SUMMARY

A technique involves providing multiple different presentations on a mobile device, and switching between the different presentations depending upon the orientation of the mobile device. For example, a first presentation could include a scripted action, which may include recorded speech or used concurrently with a speaker, and a second presentation that enables free play within a model. When the mobile device is held in a first orientation, the scripted action is used to present a pitch, lesson, or the like. When the mobile device is held in a second orientation, the free play enables a user of the mobile device to illustrate reactions within a model by way of example or in response to questions that can most effectively be answered within a model.

Continuing the example of the preceding paragraph, a specific implementation of the technique enables a person to switch between linear scripted content and free play. For example, a person conducting linear scripted product detailing using a mobile device that displays the linear scripted content can flip the mobile device, enabling the person to continue with a contextual free play biological simulation using the mobile device to display the free play biological simulation content. The person can switch back to the linear presentation when the free play presentation has served its purpose.

A system making use of the technique can be implemented on a mobile device, such as a tablet computer or smart phone.

### BRIEF DESCRIPTION OF THE DRAWINGS

FIG. 1 depicts a diagram of an example of a system for utilizing an orientation-sensitive context switching presentation device.

FIG. 2 depicts a flowchart of an example of a method for device orientation-sensitive context switching during a presentation.

FIG. 3 depicts a diagram of a presentation scene map (PSM) system.

FIG. 4 depicts a diagram of an example of a conceptual navigation map for PSM packages.

FIG. 5 depicts a flowchart of an example of a PSM use case process flow.

FIGS. 6-10 depict diagrams of examples of devices performing techniques described in this paper.

### DETAILED DESCRIPTION

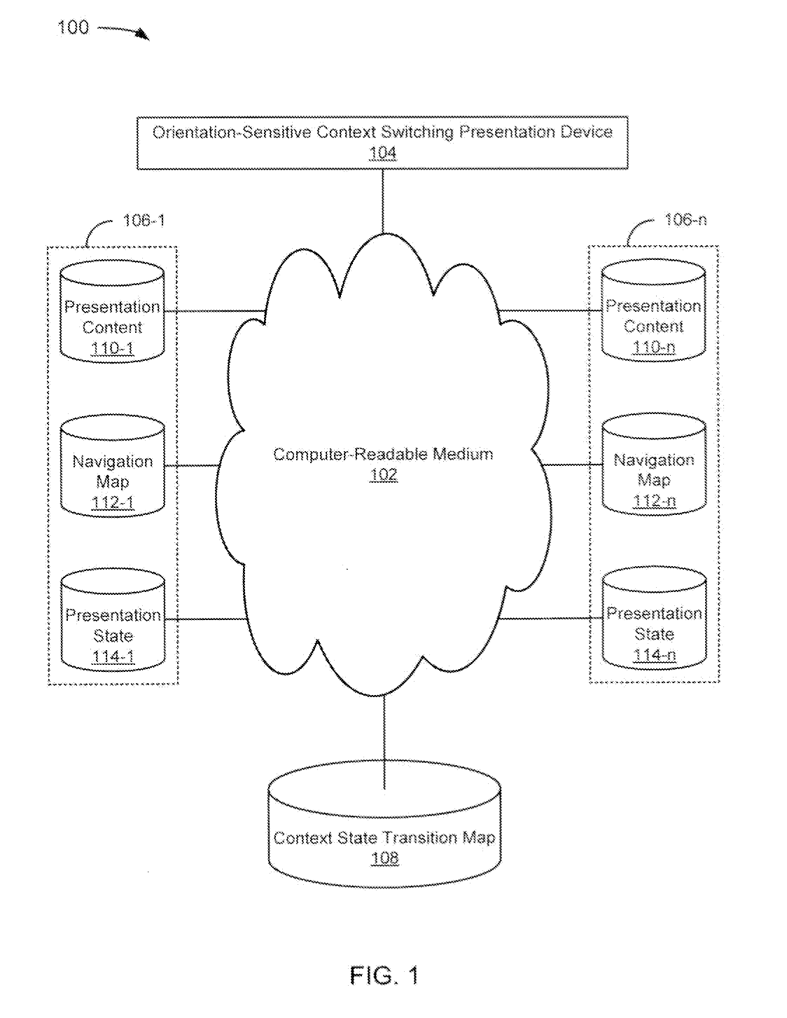

FIG. 1 depicts a diagram 100 of an example of a system for utilizing an orientation-sensitive context switching presentation device. The diagram 100 includes a computer-readable medium 102, an orientation-sensitive context switching presentation device 104, presentation datastores 106-1 to 106-n (referred to collectively as “presentation datastores 106”), and a context state transition map datastore 108.

In the example of FIG. 1, the computer-readable medium 102 can include communications hardware within a single computer, a device locally attached to a computer, or a networked system that includes several computer systems coupled together, such as a local area network (LAN), campus area network (CAN), municipal area network (MAN), or wide area network (WAN), but could include any applicable type of network, such as a personal area network (PAN).

A computer system, as used in this paper, is intended to be construed broadly. In general, a computer system will include a processor, memory, non-volatile storage, and an interface. A typical computer system will usually include at least a processor, memory, and a device (e.g., a bus) coupling the memory to the processor.

The processor can be, for example, a general-purpose central processing unit (CPU), such as a microprocessor, or a special-purpose processor, such as a microcontroller.

The memory can include, by way of example but not limitation, random access memory (RAM), such as dynamic RAM (DRAM) and static RAM (SRAM). The memory can be local, remote, or distributed. As used in this paper, the term “computer-readable storage medium” is intended to include only physical media, such as memory. As used in this paper, a computer-readable medium is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware.

The bus can also couple the processor to the non-volatile storage. The non-volatile storage is often a magnetic floppy or hard disk, a magnetic-optical disk, an optical disk, a read-only memory (ROM), such as a CD-ROM, EPROM, or EEPROM, a magnetic or optical card, or another form of storage for large amounts of data. Some of this data is often written, by a direct memory access process, into memory during execution of software on the computer system. The non-volatile storage can be local, remote, or distributed. The non-volatile storage is optional because systems can be created with all applicable data available in memory.

Software is typically stored in the non-volatile storage. Indeed, for large programs, it may not even be possible to store the entire program in the memory. Nevertheless, it should be understood that for software to run, if necessary, it is moved to a computer-readable location appropriate for processing, and for illustrative purposes, that location is referred to as the memory in this paper. Even when software is moved to the memory for execution, the processor will typically make use of hardware registers to store values associated with the software, and local cache that, ideally, serves to speed up execution. As used herein, a software program is assumed to be stored at any known or convenient location (from non-volatile storage to hardware registers) when the software program is referred to as “implemented in a computer-readable storage medium.” A processor is considered to be “configured to execute a program” when at least one value associated with the program is stored in a register readable by the processor.

In one example of operation, the computer system can be controlled by operating system software, which is a software program that includes a file management system, such as a disk operating system. One example of operating system software with associated file management system software is the family of operating systems known as Windows® from Microsoft Corporation of Redmond, Wash., and their associated file management systems. Another example of operating system software with its associated file management system software is the Linux operating system and its associated file management system. The file management system is typically stored in the non-volatile storage and causes the processor to execute the various acts required by the operating system to input and output data and to store data in the memory, including storing files on the non-volatile storage.

The bus can also couple the processor to the interface. The interface can include one or more input and/or output (I/O) devices. The I/O devices can include, by way of example but not limitation, a keyboard, a mouse or other pointing device, disk drives, printers, a scanner, and other I/O devices, including a display device. The display device can include, by way of example but not limitation, a cathode ray tube (CRT), liquid crystal display (LCD), or some other applicable known or convenient display device. The interface can include one or more of a modem or network interface. It will be appreciated that a modem or network interface can be considered to be part of the computer system. The interface can include an analog modem, isdn modem, cable modem, token ring interface, satellite transmission interface (e.g. “direct PC”), or other interfaces for coupling a computer system to other computer systems. Interfaces enable computer systems and other devices to be coupled together in a network.

Networks can include enterprise private networks and virtual private networks (collectively, private networks). As the name suggests, private networks are under the control of an entity rather than being open to the public. Where context dictates a single entity would control a network, it should be understood that reference to a network is a reference to the private portion subset of that network. For example, a LAN can be on a WAN, but only the LAN under the control of an entity; so if an engine controls policy on the network, it may be that the engine only controls policy on the LAN (or some other subset of the WAN). Private networks include a head office and optional regional offices (collectively, offices). Many offices enable remote users to connect to the private network offices via some other network, such as the Internet.

The term “Internet” as used herein refers to a network of networks that uses certain protocols, such as the TCP/IP protocol, and possibly other protocols such as the hypertext transfer protocol (HTTP) for hypertext markup language (HTML) documents that make up the World Wide Web (the web). Content is often provided by content servers, which are referred to as being “on” the Internet. A web server, which is one type of content server, is typically at least one computer system which operates as a server computer system and is configured to operate with the protocols of the World Wide Web and is coupled to the Internet. The physical connections of the Internet and the protocols and communication procedures of the Internet and the web are well known to those of skill in the relevant art.

For illustrative purposes, it is assumed the computer-readable medium 102 broadly includes, as understood from relevant context, anything from a minimalist coupling of the components, or a subset of the components, illustrated in the example of FIG. 1, to every component of the Internet and networks coupled to the Internet. In the example of FIG. 1, the computer-readable medium 102 can include a data path, such as a bus, in a computer. In such an implementation, one or more of the components illustrated in the example of FIG. 1 can be implemented on the same machine.

In the example of FIG. 1, the orientation-sensitive context switching presentation device 104 is coupled to the computer-readable medium 102. The orientation-sensitive context switching presentation device 104 can be implemented using engines and datastores. Engines, as described below and in this paper generally, refer to computer-readable media coupled to a processor. The computer-readable media have data, including executable files, the processor can use to transform the data and create new data. An engine can include a dedicated or shared processor and, typically, firmware or software modules that are executed by the processor. Depending upon implementation-specific or other considerations, an engine can be centralized or its functionality distributed. An engine can include special purpose hardware, firmware, or software embodied in a computer-readable medium for execution by the processor. As used in this paper, a computer-readable medium for implementation in an engine is intended to include all mediums that are statutory (e.g., in the United States, under 35 U.S.C. 101), and to specifically exclude all mediums that are non-statutory in nature to the extent that the exclusion is necessary for a claim that includes the computer-readable medium to be valid. Known statutory computer-readable mediums include hardware (e.g., registers, random access memory (RAM), non-volatile (NV) storage, to name a few), but may or may not be limited to hardware. The functionality of the client-approval-controlled locked granular content server 104 is described in greater detail below.

Datastores, as described below and in this paper generally, can be implemented, for example, as software embodied in a physical computer-readable medium on a general- or specific-purpose machine, in firmware, in hardware, in a combination thereof, or in an applicable known or convenient device or system. Datastores described in this paper are intended, if applicable, to include any organization of data, including tables, comma-separated values (CSV) files, traditional databases (e.g., SQL), or other known or convenient organizational formats.

In an example of a system where a datastore is implemented as a database, a database management system (DBMS) can be used to manage the datastore. In such a case, the DBMS may be thought of as part of the datastore or as part of another applicable depicted component, or as a separate functional unit (not shown). A DBMS is typically implemented as an engine that controls organization, storage, management, and retrieval of data in a database. DBMSs frequently provide the ability to query, backup and replicate, enforce rules, provide security, do computation, perform change and access logging, and automate optimization. Examples of DBMSs include Alpha Five, DataEase, Oracle database, IBM DB2, Adaptive Server Enterprise, FileMaker, Firebird, Ingres, Informix, Mark Logic, Microsoft Access, InterSystems Cache, Microsoft SQL Server, Microsoft Visual FoxPro, MonetDB, MySQL, PostgreSQL, Progress, SQLite, Teradata, CSQL, OpenLink Virtuoso, Daffodil DB, and OpenOffice.org Base, to name several.

Database servers can store databases, as well as the DBMS and related engines. Any of the datastores described in this paper could presumably be implemented as database servers. A server device includes a “server” engine that serves requests from “client” engines. In this paper, reference to a server is intended to be a reference to a server engine and reference to a client is intended to be a reference to a client engine. It should be understood that a client is a defined role for a given situation, and a device could include a client of a specific server and a server for a specific client simultaneously. Thus, clients can run on a device that has other clients or servers not relevant to the examples in which clients are discussed.

There are two logical views of data in a database, the logical (external) view and the physical (internal) view. In this paper, the logical view is generally assumed to be data found in a report, while the physical view is the data stored in a physical storage medium and available to a specifically programmed processor. With most DBMS implementations, there is one physical view and an almost unlimited number of logical views for the same data.

A DBMS typically includes a modeling language, data structure, database query language, and transaction mechanism. The modeling language is used to define the schema of each database in the DBMS, according to the database model, which may include a hierarchical model, network model, relational model, object model, or some other applicable known or convenient organization. An optimal structure may vary depending upon application requirements (e.g., speed, reliability, maintainability, scalability, and cost). One of the more common models in use today is the ad hoc model embedded in SQL. Data structures can include fields, records, files, objects, and any other applicable known or convenient structures for storing data. A database query language can enable users to query databases, and can include report writers and security mechanisms to prevent unauthorized access. A database transaction mechanism ideally ensures data integrity, even during concurrent user accesses, with fault tolerance. DBMSs can also include a metadata repository; metadata is data that describes other data.

The orientation-sensitive context switching presentation device 104 can include the capabilities of a mobile device, a display device, and a navigation-enabled device.

In a specific implementation, the orientation-sensitive context switching presentation device 104 can be implemented on a mobile device, such as a tablet, smart phone, or other computing device. In a specific implementation, the mobile device includes orientation sensing equipment, such as an accelerometer, compass, geolocation device, biometric sensor, optical sensor (e.g., for detecting gestures), microphone (e.g., for detecting speech), light sensor (e.g., for detecting a laser pointer directed at a particular location or moving in a meaningful way), or other known or convenient sensor, and a feedback path to an engine capable of determining an orientation of the device using data from the sensor. In another specific implementation, the mobile device can receive coordinates, such as geolocation coordinates, Cartesian coordinates (e.g., from a digital pen such as Anoto digital ink), or other known or convenient coordinate system formats. The orientation of the orientation-sensitive context switching presentation device 104 can be determined from data returned from a compass, geolocation coordinates, Cartesian coordinates, biometric and gesture data that can be detected by an optical sensor, speech data that can be detected by a speech detection device, such as a microphone, optical data that can be detected by an optical or light sensor, and other data input formats that can be used to determine orientation. An orientation can be defined as a range of orientation measurements. Where it is desirable to refer explicitly to a value within a range of an orientation, the values can be described with units of measure such as degrees, radians, or the like. When it is desirable to refer explicitly to orientation without reference to the underlying range, the orientation can be referred to as a discrete orientation; a discrete orientation defines a range of values. However, in general, it is not difficult to deduce the intended meaning of the word “orientation” from context.

In a specific implementation, the orientation-sensitive context switching presentation device 104 can be implemented on a display device, such as a tablet, smart phone, or other computing device. In a specific implementation, the display device includes a plurality of presentation datastores and a corresponding plurality of presentation engines for displaying presentation content from the plurality of presentation content datastores. Components of the presentation engines can be dedicated or shared across multiple engines. Content of the presentation content datastores or a subset thereof can be stored in a shared location or in separate locations for each of the presentation content datastores.

In a specific implementation, the orientation-sensitive context switching presentation device 104 can be implemented on a navigation-enabled device, such as a tablet, smart phone, or other computing device. In a specific implementation, the navigation-enabled device includes presentation content and a plurality of navigation map datastores and a presentation engine for displaying presentation content in accordance with the navigation map. The capabilities of the navigation-enabled device can vary. For example, navigation can be controlled by clicking hypertext or other links, pushing a button, bumping or shaking the device, or the like. The navigation map includes the rules for translating a stimulus into a navigation command to transition a presentation from a first presentation state to a second presentation state.

In the example of FIG. 1, the presentation datastores 106 include presentation content datastores 110-1 to 110-n (referred to collectively as “presentation content datastores 110), navigation map datastores 112-1 to 112-n (referred to collectively as “navigation map datastores 112”), and presentation state datastores 114-1 to 114-n (referred to collectively as “presentation state datastores 114”).

The presentation content datastores 110 include presentation content that is served to the orientation-sensitive context switching presentation device 104. The presentation content datastores 110 or portions thereof can be implemented on the same device as the orientation-sensitive context switching presentation device 104 (e.g., coupled via a bus) or the presentation content datastores 110 can be implemented on a device distinct from the device on which the orientation-sensitive context switching presentation device 104 is implemented (e.g., coupled through a network interface). The presentation content datastore 110-1 is associated with a first orientation of the orientation-sensitive context switching presentation device 104. The first orientation may or may not be configurable (e.g., a user may or may not be able to change orientation-to-presentation configurations).

As a general rule, the number of presentation content datastores 110 will depend upon the number of orientations a device can have. Typically, the number of orientations will be limited by practical considerations. As an extreme example, consider a user with a device that has a different presentation associated with each 1 of 100 different discrete orientations. If a mobile device is not held with great care, a user could easily inadvertently switch from one presentation to a next unintentionally by slightly tilting the mobile device. An example of a practical number of orientations is four (e.g., up, down, left, right, relative to a defined axis). An orientation vector can also be used. For example, the four practical orientations plus a direction-of-rotation (e.g., clockwise/counterclockwise rotation) parameter yield eight possible orientation vectors (e.g., up-to-left, left-to-down, down-to-right, right-to-up, up-to-right, right-to-down, down-to-left, and left-to-up).

The navigation map datastores 112 include navigation maps for transitioning from a first presentation to a second presentation state of a given presentation. Stimulus can be translated into a navigation command that is matched to a rule. The rule can have multiple parameters, including current device state, current device orientation, current presentation state (e.g., current slide), or the like. Thus, navigation commands include conditional navigation commands. For a linear presentation, the navigation map can enable, e.g., transitioning from a first slide to a second slide of an ordered series of slides. For a free play presentation, the navigation map can enable, e.g., transitioning from a first view within a virtual universe to a second view within a virtual universe, modifying a variable associated with the virtual universe (e.g., to add a new element, modify an element, or remove an element). The navigation map can include lateral movement along nodes of a tree or vertical movement toward a leaf or root of a tree (and perhaps subsequent lateral movement along nodes).

The presentation state datastores 114 include state associated with presentations. An active presentation has an active state. An inactive (previously active) presentation can have an inactive state. Conceptually, the datastores 114 can be treated as distinct data repositories, but in a specific implementation, a presentation state element can be shared across more than one of the presentation state datastores. Conceptually, at least two presentations will have different presentation state datastores 114. Thus, a set of presentation state elements for a first presentation is a proper (or strict) subset of a set of presentation state elements for a second presentation, and vice versa.

In the example of FIG. 1, the context state transition map datastore 108 is coupled to the computer-readable medium 102. The context state transition map datastore 108 may or may not be part of the same logical or physical datastore as one or more of the presentation datastores 106, or portions thereof, but is depicted distinctly for conceptual reasons. The context state transition map datastore 108 includes rules for transitioning from a first presentation to a second presentation depending upon the orientation of the orientation-sensitive context switching presentation device 104. The context state transition map datastore 108 may or may not save presentation state of a presentation from which a transition is made. For example, if a linear presentation is being done and the orientation-sensitive context switching presentation device 104 is flipped to a new orientation, it may be desirable to save the state of the linear presentation such that when the device is switched to an orientation with which the linear presentation is associated, the orientation-sensitive context switching presentation device 104 can continue from the last linear location.

Advantageously, using the system illustrated by way of example in FIG. 1, presenters can jump between multiple presentations on a single device by modifying the orientation of the device. For example, a user can give a linear presentation (e.g., a slide show) and jump to a free play model to demonstrate some aspect of a relevant concept, then switch back to the linear presentation and continue as before.

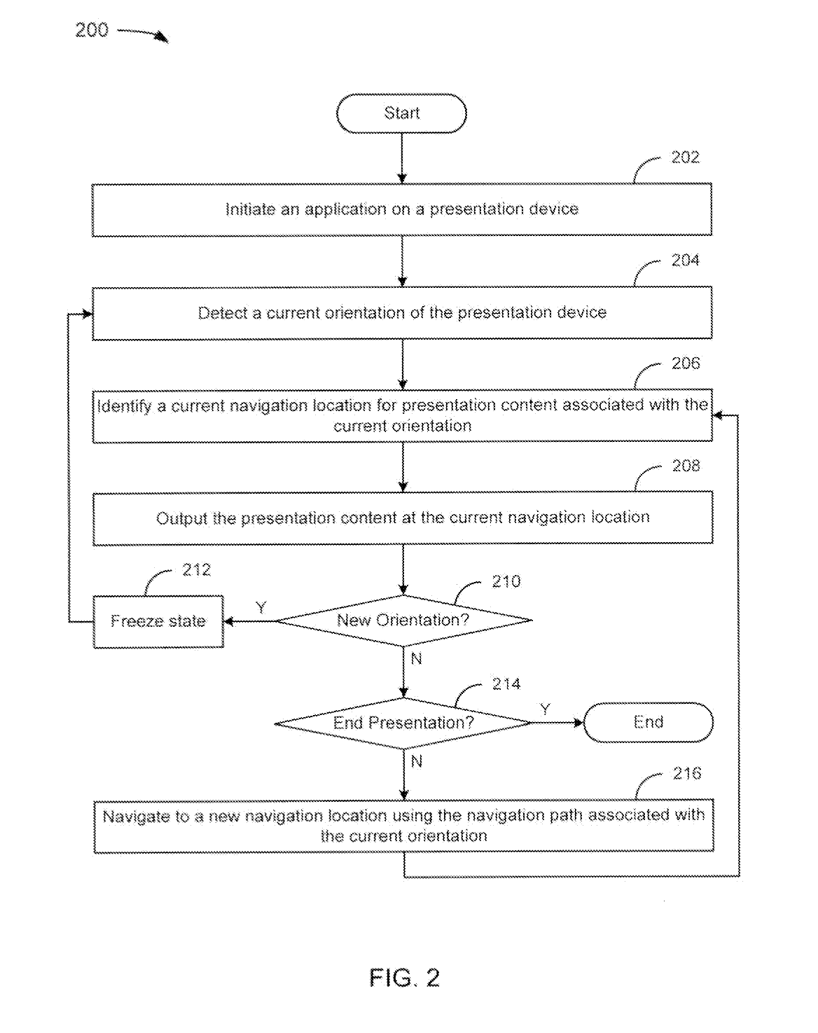

FIG. 2 depicts a flowchart 200 of an example of a method for device orientation-sensitive context switching during a presentation. The example of FIG. 2 includes serially-arranged modules, but it should be understood that the modules of the flowchart 200 and other flowcharts described in this paper could be reordered and/or arranged for parallel execution, if applicable.

In the example of FIG. 2, the flowchart 200 starts at module 202 with initiating an application on a presentation device. In a specific implementation, the application includes content and navigation map datastores for multiple presentation files and a presentation engine for navigating a presentation in accordance with the applicable navigation map and displaying content appropriate for a given device (e.g., hardware characteristics, display configurations, device orientation, etc.) state and presentation (e.g., content format, presentation history, navigation location, etc.) state. The application can display content associated with each of the multiple presentation files in accordance with a playback algorithm. For example, the multiple presentation files can include a slide deck and the application displays slides and transitions between slides in accordance with a slide presentation application. As another example, the multiple presentation files can include a video and the application displays video frames and transitions between video frames in accordance with a video presentation application. In general, a known or convenient presentation format can be matched to an applicable presentation application. The application can have an implementation-specific number of compatible formats and the multiple presentations can have same or different formats.

In a specific implementation, the application displays a splash screen when it is first initiated. Depending upon the context, the splash screen and a navigation map associated therewith are not considered part of the multiple presentations. For example, a splash screen displayed on a tablet computer may include a first format for a first orientation (say, landscape) and a second format for a second orientation (say, portrait), which is not uncommon for modern tablet display engines, but the change in orientation (from landscape to portrait) does not freeze presentation state. When an orientation-sensitive presentation is actually initiated within the application, the device will function as described in this example, using the presentation content and navigation map applicable to the orientation-sensitive presentation in a first orientation and, when orientation is changed, freezing presentation state for the first presentation and switching to presentation content and a navigation map applicable to the orientation-sensitive presentation in a second orientation.

In the example of FIG. 2, the flowchart 200 continues to module 204 with detecting a current orientation of the presentation device. In the example of FIG. 2, orientations refer to discrete orientations. Thus, detecting a current orientation can include detecting an orientation value and determining that the value falls within a range of values associated with the current orientation. As the flowchart 200 progresses, the “current” orientation changes (when device orientation changes).

In the example of FIG. 2, the flowchart 200 continues to module 206 with identifying a current navigation location for presentation content associated with the current location. Because current orientation is known, and each of multiple presentations is associated with a device orientation, the presentation content associated with the current orientation is known. The navigation location can be identified in accordance with a function of prior presentation state. The function can include a possible null value for presentation state (e.g., because the current presentation is presented before any other presentation after starting the application), which may or may not result in identifying the current navigation location as a predefined starting location.

In the example of FIG. 2, the flowchart 200 continues to module 208 with outputting the presentation content at the current navigation location. Output is in accordance with the presentation format (e.g., sound, video, a slide, etc.). In a specific implementation, content can be adjusted depending upon prior presentation state. For example, if orientation changes from a first orientation to a second orientation when a first presentation is at a first navigation location, the second presentation can be initiated (or resume) at a second navigation location; and when the first presentation is at a third navigation location different than the first navigation location, the second presentation can be initiated (or resume) at a fourth navigation location different than the second navigation location. In a specific implementation, inputs (e.g., textual inputs; inputs from other applications, such as a camera; etc.) are received during a prior presentation, the inputs can be converted into content display parameters. For example, if a word is entered in a text field of a first presentation, the word could be used in a video clip selection function, converted to sound with a language processing engine and output in a second (audio) presentation, or the like.

In the example of FIG. 2, the flowchart 200 continues to decision point 210 where it is determined whether the presentation device is flipped to a new orientation. If it is determined that the presentation device is flipped to a new orientation (210-Y), then the flowchart 200 continues to module 212 with freezing presentation state and returns to module 204 as described previously. Freezing presentation state (212) is useful for identifying current navigation location (206) and may or may not be useful for modifying conditional content (208). What state is frozen can depend upon the current presentation (prior to flipping to a new orientation). For example, a free play presentation may start over at the beginning each time it is initiated; so freezing state can entail partially or completely re-initializing the state.

As another example, freezing state can facilitate placing a first presentation into a same state as before the presentation device orientation changed to that of a second presentation and then back again. In this way, the first presentation can continue from the same location as when the change in orientation switched out of the first presentation. Advantageously, presenters can switch out of a first presentation to provide examples or other content then switch back to the first presentation without losing their places in the presentation.

As another example, freezing state can entail saving state in a historical datastore that can be referenced by multiple presentations. A presentation device can learn as time passes, and what is learned during a first presentation can be used later in a second presentation. In a specific implementation, the second presentation can also freeze state when transitioning to the first presentation. Conceptually, a subset of the presentations can freeze state. The actual datastore of frozen state can result in changes to state of a first presentation while a second presentation is active. In other words, multiple presentations can have create, read, update, delete (CRUD) permissions to a single datum of a presentation state datastore used by a subset of the multiple presentations. Advantageously, presenters can switch out of a first presentation to provide inputs in a second presentation then switch back to the first presentation with updated content on the present slide or other current content unit or updated content later during the first presentation (either as modified content in a slide or other content unit or as a conditional branch or other command).

As another example, a first presentation can include a hierarchical drill-down of n levels (the nth level comprises what is referred to in this example as “child nodes” for illustrative purposes only) and a second presentation can include a hierarchical drill-down of n−1 levels. If the first presentation is in a child node and the device orientation is changed, the second presentation may display a hierarchically higher presentation, which could be the same as what would be displayed if the first presentation was at n−1 level (the n−1th level comprises what is referred to in this example as “parent nodes” for illustrative purposes only) when the device orientation changed. Later, the device orientation can change back to that of the first presentation. Because the child and parent nodes of the first presentation transition to the same node in the second presentation, there is not one-to-one reverse mapping. Therefore, the frozen state of the first presentation can be used to identify a current navigation location that would have otherwise been ambiguous.

In the example of FIG. 2, at decision point 210, if it is determined that the presentation device is not flipped to a new orientation (210-N), then the flowchart 200 continues to decision point 214 where it is determined whether the current presentation is over. If it is determined that the current presentation is not over (210-N), the flowchart 200 continues to module 216 with navigating to a new navigation location using the navigation path associated with the current orientation, then the flowchart returns to module 206 and continues as described previously. Navigation can be accomplished in a number of ways that varies depending upon the capabilities of a presentation device, such as by selecting from a menu bar, swiping the screen, typing in or choosing a link, etc.

If, on the other hand, it is determined that the current presentation is over (210-Y), the flowchart 200 ends. This can be accomplished by reaching the end of applicable presentation content. Ending may or may not result in the application displaying a “splash screen” from which a presentation can be initiated, which can include returning to module 202 (not shown). It may or may not be the case that the presentation can be repeated or can be looped back to some prior point, which can include returning to decision point 210 (not shown).

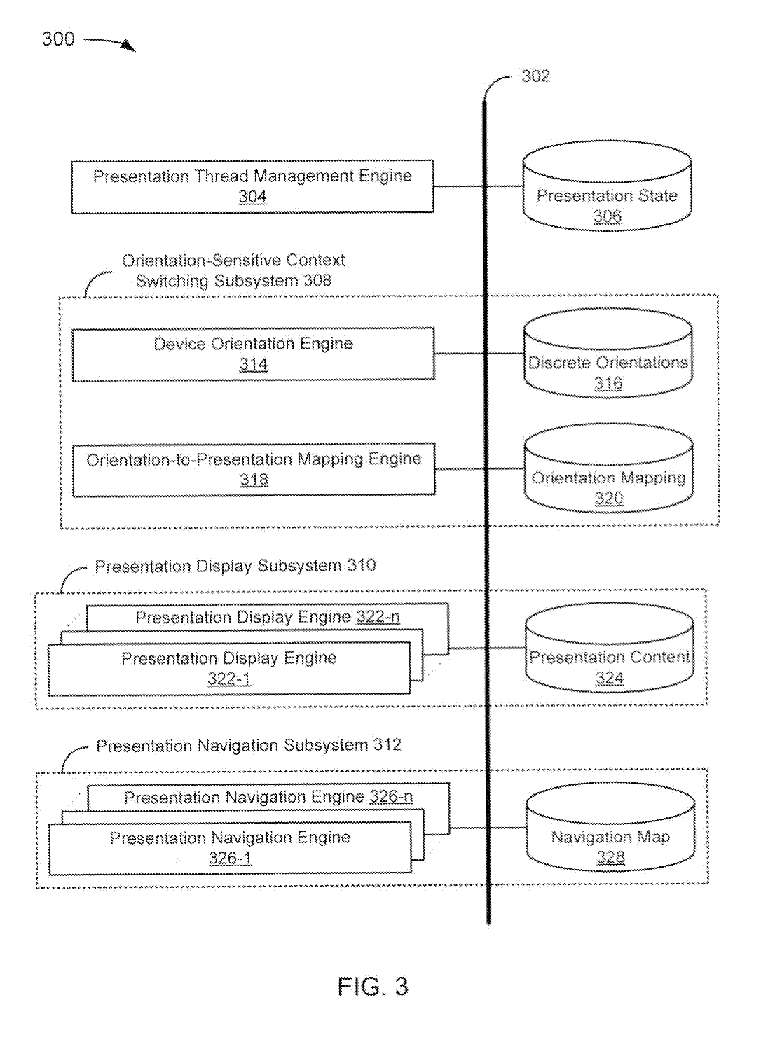

FIG. 3 depicts a diagram 300 of a presentation scene map (PSM) system. The diagram includes a computer-readable medium 302, a presentation thread management engine 304 coupled to the computer-readable medium 302, a presentation state datastore 306 coupled to the computer-readable medium 302, an orientation-sensitive context switching subsystem 308 coupled to the computer-readable medium 302, a presentation display subsystem 310 coupled to the computer-readable medium 302, and a presentation navigation subsystem 312 coupled to the computer-readable medium 302.

A PSM, as used in this paper is a plurality of presentations, each of which is associated with a discrete orientation of a device on which the PSM is implemented. The presentations of a PSM can be characterized as an active presentation and one or more inactive presentations. The active presentation, as used in this paper, is the presentation that is being currently displayed on a display device of the mobile device on which the PSM is implemented. The inactive presentations, as used in this paper, may or may not have been active presentations at some point in time. The presentations of the PSM can alternatively be characterized as presentation threads. Presentation threads, as used in this paper, are presentations that include any presentation with saved presentation state (e.g., the active presentation or a previously active presentation).

In a specific use case, the PSM represents a medical regulatory (MedReg)-approved presentation bundle. Making use of MedReg-approved PSMs can reduce the risk of a presenter going off-label. For example, a PSM could be linked to a Medical Regulatory Board (MedReg) number to represent a form of approval. In such an implementation, the content can be referred to as “MedReg-controlled content.” A user of the system would know whether content that they are using is MedReg-controlled, and make decisions accordingly. A Medical Regulatory Board typically decides on MedReg approval in accordance with legal requirements.

For illustrative purposes while describing the example of FIG. 3, a PSM includes ‘n’ presentations. The number of discrete orientations of a device on which the PSM is implemented will also be ‘n’. By definition, each of the presentations of the PSM can be mapped to a particular discrete orientation. It may be noted that a mobile device may be capable of recognizing more than ‘n’ discrete orientations, but for illustrative purposes, the presentation thread management engine manages only ‘n’ threads. Any discrete orientations beyond ‘n’ can be redundantly mapped to a PSM presentation, used as an escape sequence (e.g., to revert to a splash screen, switch to a high level PSM selection menu, initiate or switch to another application, switch to a different PSM instance, to name several).

In the example of FIG. 3, the computer-readable medium 302 can be implemented in a manner similar to that of the computer-readable medium 102 (FIG. 1).

In the example of FIG. 3, the presentation thread management engine 304 and the presentation state datastore 306 are coupled to the computer-readable medium 302. The presentation thread management engine 304 maintains state in the presentation state datastore 306 for one or more presentations of a PSM.

Presentation state for an active presentation can be impacted by the orientation-sensitive context switching subsystem 308, the presentation display subsystem 310, the presentation navigation subsystem 312, and other subsystems (e.g., a user input processing subsystem, a sensor input processing subsystem, etc.). Presentation state can be modified in accordance with data derived from subsystems and state modification rules. State modification rules can include super global rules (e.g., covering a plurality of PSMs), global rules (e.g., rules that are applicable to all presentations of a PSM), and local rules (e.g., rules that are applicable to particular presentations). In an object-oriented context, the rules can be defined within objects.

In the example of FIG. 3, the orientation-sensitive context switching subsystem 308 includes a device orientation engine 314, a discrete orientations datastore 316, an orientation-to-presentation mapping engine 318, and an orientation mapping datastore 320. The device orientation engine 314 includes a known or convenient sensor for determining an orientation value of a mobile device. The sensor can detect actual orientation or changes in orientation and provide sensor data to a processor for converting the data into useful estimates, approximations, or other values indicative of a current orientation of the mobile device. In a specific implementation, the device orientation engine 314 is implemented entirely on the mobile device. In alternative implementations, some of the device orientation engine 314 could be implemented on a different device (e.g., a network server, a wireless device on a WiFi network, or the like).

In a specific implementation, current orientation is a context-free orientation. What is meant by “context-free” in this case is that discrete orientations recognized by the orientation-sensitive context switching subsystem 308 are measurements or estimates of current location without regard for prior orientation (the context being the prior orientation and the context-free orientation being the current physical orientation of the device). In a specific implementation, current orientation is relative orientation. What is meant by “relative” in this case is that discrete orientations recognized by the orientation-sensitive context switching subsystem 308 are measurements or estimates of current location based upon a change from a prior orientation. For example, a PSM could include two presentations, one associated with a clockwise orientation and one associated with a counterclockwise orientation, without regard for whether the mobile device is currently upright, upside down, right side up, or left side up. In a specific implementation, current orientation is defined as an orientation vector that combines both a context-free orientation and a relative orientation. For example, if a mobile device is turned upside-down in a clockwise direction, the mobile device may be associated with a first orientation while if the mobile device is turned upside-down in a counterclockwise direction, the mobile device may be associated with a second orientation. Generally, the meaning of “orientation” can be derived from context and more specific definitions like context-free orientation, relative orientation, and orientation vector are used when needed to make a point.

The discrete orientations datastore 316 includes parameters for ‘n’ different orientations to which data from sensors of the device orientation engine 314 can be mapped. In a specific implementation, each of the parameters represents a range or sensitivity that ideally results in all of the possible permutations of data mapping to a discrete orientation. If a discrete orientation changes, the device orientation engine 314 can trigger an alert or initiate a process to deactivate an active presentation associated with the prior orientation and activate a currently inactive presentation associated with the new orientation.

The orientation-to-presentation mapping engine 318 uses a mapping of a discrete orientation to a presentation in the orientation mapping datastore 320 to map the discrete orientation identified by the device orientation engine 314 to a presentation associated with the discrete orientation. Thus, when the device orientation engine 314 detects a change from a first discrete orientation to a second discrete orientation, the orientation-to-presentation mapping engine can provide an identification of a presentation that should be activated.

It may be noted that the engines and datastores of the orientation-sensitive context switching subsystem 308 depicted in the example of FIG. 3 can be combined to create an engine that maps an orientation value to a presentation without the intermediate processing to map an orientation value to a discrete orientation though the determination of a discrete orientation is still conceptually useful when describing to a user how a mobile device can be turned “upside down” (a discrete orientation) to activate a particular presentation. In other words, regardless of the underlying logic, a human will often find discrete orientations useful categories of ranges of orientation values.

When an active presentation is deactivated, the presentation thread management engine 304 can save thread state for the deactivated presentation just prior to deactivation. It may be noted that as long as state is saved appropriately, it makes little difference when (before or after the active thread is deactivated), but as a practical matter, state is often saved prior to deactivation because deactivation can entail overwriting values, destroying the old value if not saved. Different implementations and/or technologies could conceivably impact the necessity of saving state prior to deactivating an active presentation.

In the example of FIG. 3, the presentation display subsystem 310 includes presentation display engines 322-1 to 322-n (referred to collectively as the “presentation display engines 322”) and a presentation content datastore 324. In a specific implementation, the presentation display engines 322 share hardware such as a display device (e.g., a screen, speakers, radio transmitter, or the like), drivers, processors, etc.

In a specific implementation, each of the presentation display engines 322 corresponds to a discrete orientation in the discrete orientations datastore 316. Thus, the orientation-to-presentation mapping engine 318 can identify a relevant one of the presentations to be activated or reactivated by the relevant one of the presentation display engines 322.

The presentation content datastore 324 is depicted as a single datastore. However, the presentation content datastore 324 is intended to represent a store of relevant presentation content for all of the presentations, regardless of the physical characteristics of the datastore.

In the example of FIG. 3, the presentation navigation subsystem 312 includes presentation navigation engine 326-1 to 326-n (referred to collectively as the “presentation navigation engines 326”) and a navigation map datastore 328. In a specific implementation, the presentation navigation engines 326 share hardware such as an input device (e.g., a touch screen, keypad, microphone, radio receiver, or the like), drivers, processors, etc. Depending upon the implementation, some input devices can include the ability to detect special input sequences (e.g., a swipe, double-click, command phrase, or the like).

In a specific implementation, each of the presentation navigation engines 326 corresponds to a discrete orientation in the discrete orientations datastore 316. Thus, the orientation-to-presentation mapping engine 318 can identify a relevant one of the presentations to be activated or reactivated by the relevant one of the presentation navigation engines 326.

The navigation map datastore 328 is depicted as a single datastore. However, the navigation map datastore 328 is intended to represent a store of relevant presentation navigation options for all of the presentations, regardless of the physical characteristics of the datastore.

In the example of FIG. 3, in operation, the various subsystems operate concurrently. Depending upon implementation- and technology-specific details, what is meant by “concurrently” can vary. For example, specific engines could make use of a shared processor that cycles through the various engine commands. To a human who is using a mobile device on which the engines are implemented in whole or in part, the engines can appear to be operating at the same time despite the underlying hardware sharing that actually means the engines are taking turns. Some engines may make use of interrupts, hooks, or the like.

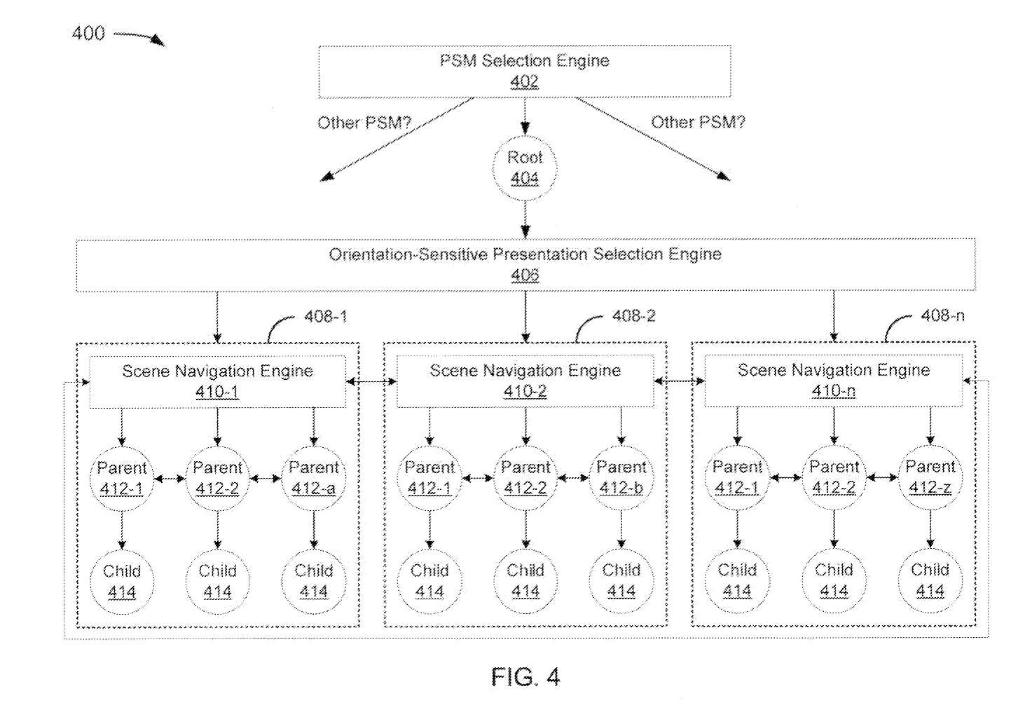

FIG. 4 depicts a diagram 400 of an example of a conceptual navigation map for PSM packages. The diagram 400 depicts a PSM selection engine 402, a PSM root node 404 coupled to the PSM selection engine 402, an orientation presentation selection engine 406 coupled to the root node 404, and presentation nodes 408-1 to 408-n (collectively referred to as “presentation nodes 408”) coupled to the orientation-sensitive presentation selection engine 406. In a typical use case, a presenter will initiate a top-level PSM application on a mobile device in order to obtain access to a desired PSM. The features of a PSM application can vary depending upon the implementation. For example, initiating the PSM application can open a directory of PSMs; cause a menu to be displayed on a screen; trigger an alert to a server to enable monitoring of a presentation; pull data from a calendar, contacts, or other business datastore; or the like. At least one feature of the PSM application is enabling a human or artificial agent to select of a PSM (the root node 404 is a conceptual “handle” of the selected PSM).

In the example of FIG. 4, the PSM selection engine 402 selects a PSM that is to be initiated. There may or may not be multiple PSMs from which the PSM selection engine 402 can choose, which is illustrated in the example of FIG. 4 with the arrows on either side of the root node 404 labeled “other PSM?” In a specific implementation, the organization and selection of PSMs is accomplished using a convenient mechanism, such as selecting from a directory, selecting from a list, using a search engine, or the like. For example, PSMs associated with a particular brand could be grouped into a brand bucket to enable a presenter who intends to provide a presentation associated with the particular brand to search the brand bucket for an appropriate PSM. If only one PSM can be selected and/or if a particular PSM is indicated to be the default at a given time, the PSM selection engine 402 can select the particular PSM automatically (e.g., without waiting for or considering input from a user).

In the example of FIG. 4, the root node 404 is intended to represent a conceptual PSM handle. When a PSM system initiates a PSM, a person making use of the PSM system will typically be provided some form of indication that the PSM has been initiated (e.g., by displaying a splash screen, a top-level control menu, or the like). The indication, if any, can be conceptually associated with the root node 404. The PSM selected by the PSM selection engine 402 may or may not also include an identifier (e.g., a file name, key value, or the like) that can be conceptually associated with the root node 404.

In the example of FIG. 4, the orientation-sensitive presentation selection engine 406 is intended to represent a mechanism for choosing a presentation of the selected PSM appropriate for a discrete orientation. For illustrative purposes, to the extent there is an initial orientation-independent scene (e.g., a universal starting point for all presentations of a PSM), the orientation-independent scene is considered part of the root node 404; and the orientation-sensitive presentation selection engine 406 is intended to represent a gateway between any initial orientation-independent scenes and orientation-dependent scenes. It may be noted that an initial orientation-independent scene could include a locked orientation-dependent scene. For example, a starting point of a first presentation could be displayed initially and locked so that an orientation of a device on which at least a portion of the PSM system is implemented is prevented from switching to a different scene. Upon receiving a stimulus (e.g., swiping the screen, shaking the device, entering a start command, or the like), the orientation-sensitive presentation selection engine 406 can select a presentation and, if the locked scene is the same as the relevant presentation's starting scene display a scene that appears the same as the initial orientation-independent scene.

In a specific implementation, parameters of the orientation-sensitive presentation selection engine 406 can be modified while one of a subset of the presentations is active. For example, a presenter may find it useful to lock a scene so that reorienting a device outputting the scene does not switch to a different presentation. Conceptually, in this example, scenes can be locked so as to effectively force the orientation-sensitive presentation selection engine 406 to always choose the locked presentation (or switch between fewer than ‘n’ of the presentations, including at least the locked presentation). As another example, a presenter may find it useful to make a presentation unreachable with orientation changes. Conceptually, in this example, scenes can be blocked so as to effectively force the orientation-sensitive presentation selection engine 406 to never choose the blocked presentation (or switch between fewer than ‘n’ of the presentations, at least excluding the blocked presentation) Presenters may or may not also be able to configure device sensitivity to make orientation value ranges that define a discrete orientation larger or smaller.

In the example of FIG. 4, the presentation nodes 408 are intended to represent each of ‘n’ presentations of the selected PSM. Each of the presentation nodes includes one of a scene navigation engine 410-1 to 410-n (collectively referred to as “scene navigation engines 410”), parent nodes 412-1 to 412-x (referred to collectively as “parent nodes 412”) coupled to an applicable one of the scene navigation engines 410, and child nodes 414-1 to 414-x (referred to collectively as “child nodes 414”) respectively coupled to the parent nodes 412.

In the example of FIG. 4, the scene navigation engines 410 of the presentation nodes 408 are depicted as coupled to one another to represent state-sharing. In a specific implementation, one or more of the scene navigation engines 410 include a scene identification function with an input parameter that includes state from all or a subset of the ‘n’ scene navigation engines. The input parameters of the scene identification function can include state for the one or more of the scene navigation engines 410. For example, if a presenter navigates from a default first slide to a second slide of a first presentation, the orientation-sensitive presentation selection engine 406 activates a second presentation, and the orientation-sensitive presentation selection engine 406 later reactivates the first presentation, the first presentation can restart at the second scene as opposed to the default first scene. As another example, if a presenter navigates to a second scene of a first presentation and the orientation-sensitive presentation selection engine 406 activates a second presentation, the scene navigation engine of the second presentation can start at a second scene identifiable using a function that accepts has an input parameter state from the scene navigation engine of the first presentation.

In the example of FIG. 4, the scene navigation engines 410 are depicted as pointing to each of the parent nodes 412 of the respective presentation nodes 408, which is intended to represent the ability to navigate to any ordered scene within a presentation. To make use of a relatively well-known scene presentation system, the scenes can be, for the purpose of illustration, described as slides that are traversed in a known or convenient manner. For example, a first slide can be a starting slide for the presentation. Other slides can be ordered to follow the first slide in a sequential order. Using commands, a presenter can jump from one slide to another. In addition to universal navigation commands (e.g., “click” to go to the next slide) navigation commands (which can also be considered part of the scene navigation engine 410) may or may not be provided in slides to enable navigation through the various slides in a non-sequential manner.

In the example of FIG. 4, the parent nodes 412 are intended to represent a top hierarchical node of the presentation nodes 408 (and can be characterized as one or more “roots” of a presentation tree, where the root node 404 is characterized as a root of a PSM tree). The number of parent nodes can be equal to a number of slides in a slide deck. For a free play presentation, the number of parent nodes can equal one. In some instances, such as a virtual world environment, the number of parent nodes could be treated as locations within the virtual world (e.g., in a three-dimensional virtual world environment, the number of parent nodes could be considered to be the product of three coordinate values). For a video presentation, the number of parent nodes could be considered to be the number of frames or i-frames or time elapsed of the video presentation. For an audio presentation, the number of parent nodes could be considered to be time elapsed or line number, sentence number, page number, or chapter (e.g., if originating from a text or transcribed) of the audio presentation.

In a specific implementation, the parent nodes of a first presentation can be correlated with the parent nodes of a second presentation. For example, if a navigation location of a first presentation is parent node 412-2 and the orientation-sensitive presentation selection engine 406 switches to a second presentation, the scene navigation engine of the second presentation can be configured to select parent node 412-2 as a navigation location of the second presentation. The correlation between parent nodes can be one-to-one or one-to-many. Depending upon the implementation-, configuration-, and/or PSM-specific factors, the correlated navigation may or may not be overridden by other presentation state.

In the example of FIG. 4, the child nodes 414 are depicted as silos that do not communicate with other ones of the child nodes 414 within a specific one of the presentation nodes 408 (“siblings”) or within other ones of the presentation nodes 408 (“cousins”). The conceptual silo is intended to illustrate how there is no corresponding node in other presentations. For example, if navigation passes from parent node 412-1 to child node 414 of the presentation node 408-1 and the orientation-sensitive presentation selection engine 406 activates the presentation node 408-2, the scene navigation engine 410-2 can select the corresponding parent node 412-1, but cannot select the child node 414 of the parent node 412-1. That said, if the orientation-sensitive presentation selection engine 406 reactivated the presentation node 408-1, the navigation may or may not, depending upon implementation-, configuration-, and/or PSM-specific factors, resume at the child 414 of the parent node 412-1.

Depending upon the node, a subset of the parent nodes 412 may or may not have a child node. Conceptually, such parent nodes can be characterized as having a NULL child node. Depending upon the implementation, a conceptually NULL child node could be representative of a parent node that is either capable of having a child node but does not or is incapable of having a child node due to implementation-, configuration-, or PSM-specific factors. If a child node is conceptually NULL, the corresponding parent node can be referred to as a “leaf” node instead.

Depending upon the node, a subset of the parent nodes 412 may or may not have one child node. If the child node has no children, which, from the perspective of the parent node are “grandchildren,” the child node can be referred to as a “leaf” node. If the child node has children, the child node can be referred to as an “inner” node, a child subtree root, or a silo subtree root. It may be noted that a child leaf node can be referred to as a child subtree root or a silo subtree root, as well, but the subtree will have a single node.

Depending upon the node, a subset of the parent nodes 412 may or may not have multiple sibling child nodes (only one of which is depicted in the example of FIG. 4). When there are multiple sibling child nodes, the scene navigation engines 410 select the appropriate one of the sibling child nodes using state information and/or navigation commands.

Each node hierarchy can be described as having a node navigation engine (not shown) for determining to which sibling node navigation should proceed. Conceptually (or actually, depending upon the implementation), each of these node navigation engines are treated as part of the scene navigation engines 410.

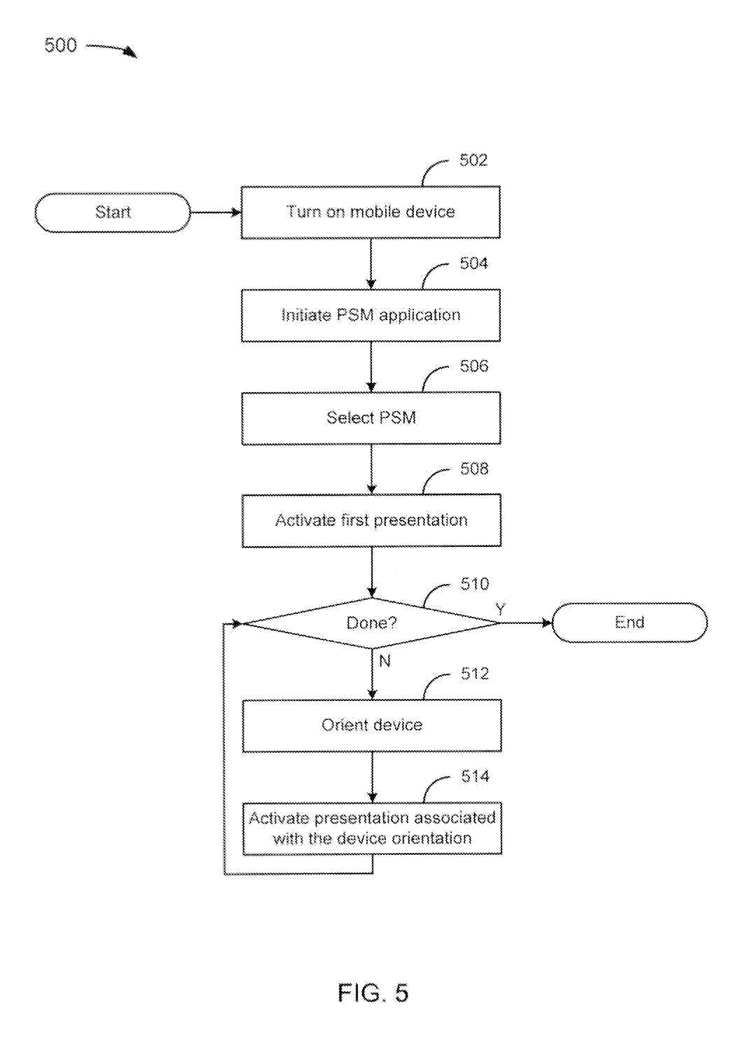

FIG. 5 depicts a flowchart 500 of an example of a PSM case process flow. In the example of FIG. 5, the flowchart 500 starts at module 502 with turning on a mobile device. In a specific implementation, the mobile device comprises a presentation display device, an orientation-sensitive device, and a presentation navigation device. An output device, such as a display screen, can be used by the mobile device in a convenient manner when the mobile device is turned on. For example, turning on the mobile device can result in a display of, for example, an information bar with data such as time, battery life, and wireless signal strength; multiple selectable application links; and a menu bar.

In the example of FIG. 5, the flowchart 500 continues to module 504 with initiating a PSM application. In a specific implementation, the mobile device receives an indication that the PSM application is to be initiated by detecting a click on a link associated with the PSM application or receiving some other stimulus to trigger the PSM application. The PSM application may or may not instead or in addition be initiated automatically by placing a link to the application in a start menu or the equivalent that initiates the PSM application when the mobile device is powered on. In a specific implementation, the mobile device can be configured for presentation only mode by initiating the PSM application when the mobile device is turned on and preventing other uses of the mobile device (e.g., personal or for presentations that have not been approved by a regulatory board). This configuration can be accomplished by a person or an agent of a person or legal entity with some ownership interest in the mobile device or the contents therein.

In the example of FIG. 5, the flowchart 500 continues to module 506 with selecting a PSM. In a specific implementation, the mobile device receives an indication that a PSM is to be initiated by detecting a click on a link associated with the PSM or receiving some other stimulus to select the PSM. The PSM may or may not instead or in addition be selected automatically when the PSM application is initiated. In a specific implementation, the PSM application can be configured to allow access to only one PSM when the PSM application is initiated or limit access based on user credentials or whether a PSM has been approved by a regulatory board. This configuration can be accomplished by a person or an agent of a person or legal entity with some ownership interest in the mobile device or the contents therein.

In the example of FIG. 5, the flowchart 500 continues to module 508 with activating a first presentation. The selected PSM (506) may or may not have a default starting point. For example, the first presentation could be activated after a discrete orientation of the orientation-sensitive device is detected (not shown, but see module 512 below), where the detected discrete orientation is associated with the first presentation. As another example, the first presentation could be activated automatically when the PSM is selected regardless of the discrete orientation (measured or not) of the orientation-sensitive device as a starting point of the PSM. However, this does not necessarily mean the first presentation will last for any particular length of time before the flowchart 500 continues to decision point 510; so time spent at the default starting point could be brief.

In the example of FIG. 5, the flowchart 500 continues to decision point 510 where it is determined whether the PSM activity is done. It is typically desirable to give some level of control over when a presenter is finished to the presenter; so determining whether the PSM activity is done will typically occur when an indication is received from the presenter indicating as much. However, there is no technical reason the PSM activity could not be ended in accordance with some other stimulus, such as a time limit being reached (which might be appropriate in certain gaming environments), a cost limit is reached (e.g., if the presenter or audience is only entitled to a certain cash-value of the PSM activity or the presenter is consuming resources at a server). There are also instances where the PSM activity has not truly ceased, but the PSM activity is less meaningful. For example, if the PSM activity includes a live feed as one of the applicable presentations, if a meeting, convention, tournament, or the like adjourns and nobody is left on the live feed, the PSM activity might be considered to have, at least for practical purposes, have ended, even if the PSM activity is not shut down explicitly. For illustrative purposes in this example, it is assumed if the PSM engines are running, the PSM activity is ongoing, even if the PSM activity is not particularly meaningful.

If it is determined that the PSM activity is done (510-Y), then the flowchart 500 ends. If, on the other hand, it is determined that the PSM activity is not done (510-N), then the flowchart continues to module 512 with orienting the device. Orienting the device involves detecting movement relative to an environment of the device (e.g., rotating, shaking, swinging, or otherwise moving the device around) or detecting a current orientation relative to a baseline orientation. In a specific implementation, the device itself is orientation-sensitive. For example, sensors can be located on the device to enable the device to obtain sensor feedback useful in determining the orientation of the device. The feedback may or may not be processed at the device (e.g., sensor feedback could be sent over a wireless link to a server, or the device can determine a discrete orientation of the device with an internal processor, the latter being well within the bounds of current popular tablet computer technologies). In a specific implementation, the device itself is not orientation-sensitive, but in combination with an external sensor, the device becomes an orientation-sensitive device. For example, a camera can capture an image of a device as it moves over time and a discrete orientation of the device can be derived therefrom. An example of a typical orientation-sensitive device is an ipad, which can determine its own orientation. Another example of an orientation-sensitive device is a computer and a mobile device (e.g., a wand, “air mouse,” or the like) coupled to the computer via a wired or wireless link. The computer can process sensor feedback from the mobile device or the feedback can be provided to an external server for processing the sensor feedback.

In the example of FIG. 5, the flowchart 500 continues to module 514 with activating a presentation associated with the device orientation and returns to decision point 510 as described previously, forming a loop including decision point 510, module 512, and module 514. As has been explained previously, each presentation of the PSM is associated with a discrete orientation of the orientation-sensitive device.

In a specific implementation, the device itself includes a presentation display device on which scenes of the presentation are displayed. For example, the device can include speakers and a screen one or both on which the scenes are displayed. In a specific implementation, the device itself does not include a presentation display device, but in combination with an external display device, the device becomes a presentation display device. For example, data can be sent from the device to a projector (or screen and/or sound system) via a wired or wireless link and the speakers and/or video projection device can present scenes of the presentation to an audience. The device may or may not include a redundant display device for the presenter (e.g., an iphone screen) while scenes are presented to an audience using a projector or other display device.

In a specific implementation, the device itself includes a presentation navigation device by which control stimuli can be received. For example, the device can include touch screen for receiving tactile input from a presenter, a microphone for receiving audio signals, or the like. In a specific implementation, the device itself does not include a presentation navigation device, but in combination with an external input device, the device becomes a presentation navigation device. For example, data can be received at the device from an input device (e.g., a keyboard, “air mouse,” microphone, or the like) via a wired or wireless link and the device can process the input. The device may or may not include redundant input devices. Determining a navigation location from processed input signals can be done using a processor of the device, but can instead conceivably be done at an external server.

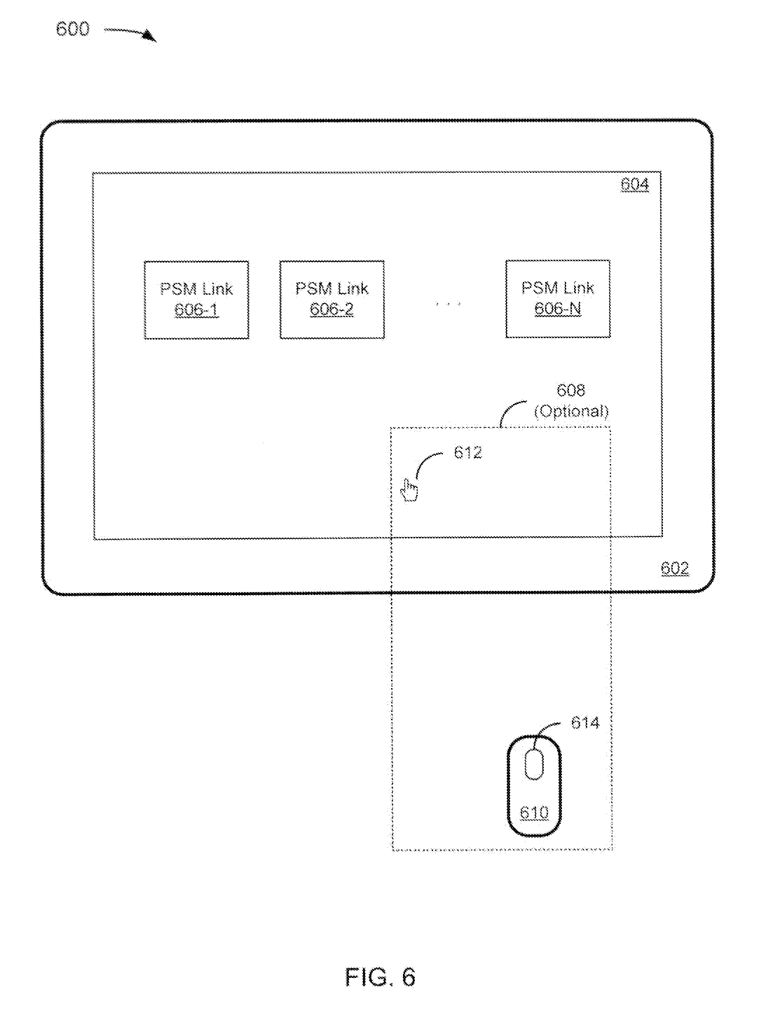

FIGS. 6-10 depict diagrams 600-1000 of examples of devices performing techniques described in this paper. In the example of FIG. 6, the diagram 600 depicts a display device 602 with a screen 604 having PSM links 606-1 to 606-N (referred to collectively as “PSM links 606”); the diagram 600 also depicts an example of an optional input device subsystem 608.

In the example of FIG. 6, the display device 602 is intended to represent a mobile computing device, a desktop computer, a projector, or some other device capable of prompting a user to select a PSM. In a specific implementation, the display device 602 is part of a tablet computer device, an engine of which prompts a user to select a PSM by displaying the PSM links 606 on the screen 604. The user can press an active portion of the screen 604 to select one of the PSM links 606.

In an alternative implementation, the display device 602 is part of some other display system, such as a projection system. The display device 602 could even be implemented as an audio device (with a corresponding input device, such as a speech recognition subsystem, that enables a user to select one of the PSM links 606 verbally). For a display device 602 that does not also function as an input device, such as a touch screen, it may be desirable to include the optional input device subsystem 608. Even in cases where the display device 602 can function as an input device, it may be desirable to redundantly include the optional input device subsystem 608.

In the example of FIG. 6, the input device subsystem 608 includes an input device 610, a cursor 612 displayed on the screen 604, and button 614. The input device 610 can include a mouse, joystick, keyboard, touchpad, laser pointer, or some other convenient input device. The cursor 612 can be displayed in a manner similar to the PSM links 606 (e.g., the cursor 612 is displayed on the screen 604) or the cursor 612 can be projected onto the screen 604 using a projection device (e.g., a laser pointer). The purpose of the cursor 612 is to enable a user to direct a selection point by sight, and a convenient technique can be used to provide this function. When the cursor 612 is at a desired selection point, such as on top of one of the PSM links 606, the button 610 can be activated to complete the selection. The button 610 can be implemented in a convenient manner, such as a mouse or other button, switch, action (e.g., tap or bump), or the like.

By selecting one of the PSM links 606, a user can initiate a PSM. It may be noted that an implementation that includes none of the optional elements of the optional input device subsystem 608 may still be characterized as including an input device subsystem 608. For example, a touch screen and relevant engines can be characterized as the input device subsystem 608. It may be further noted that PSM selection can be accomplished automatically when a relevant application is initiated (e.g., there may be only one PSM for a given application or the application may be configured to initiate a particular PSM when the application is initiated).

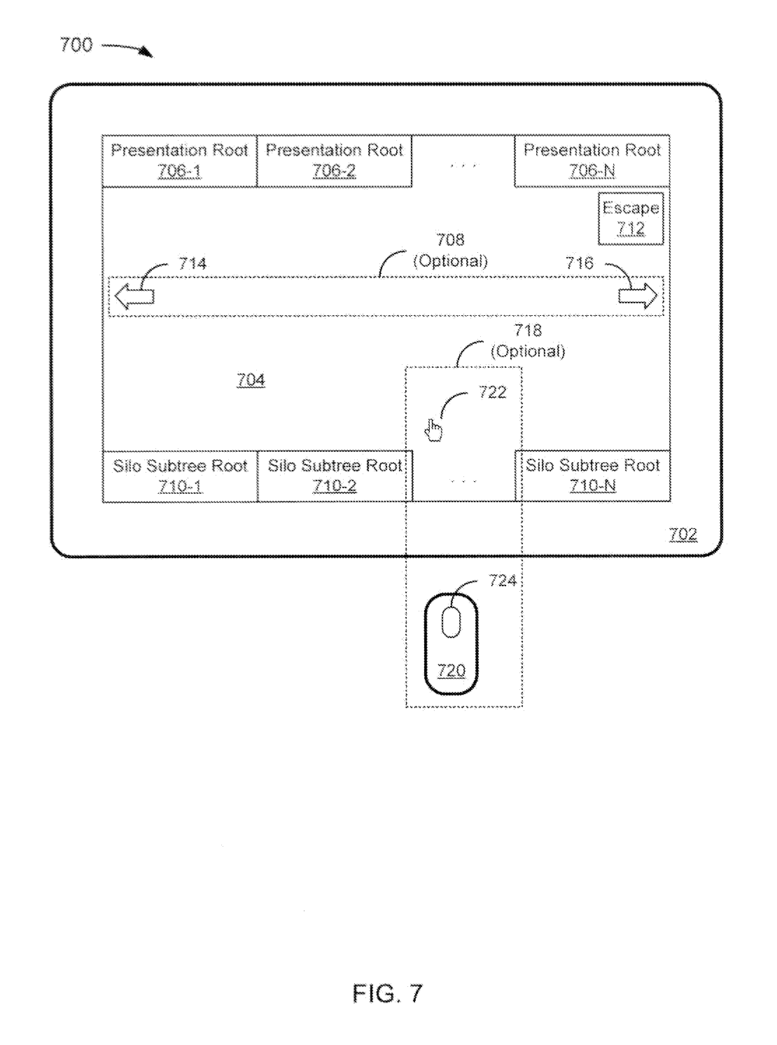

In the example of FIG. 7, the diagram 700 depicts a display device 702 with a screen 704 having a presentation scene and a navigation map. The navigation map includes presentation root links 706-1 to 706-N (referred to collectively as the presentation root links 706 or the presentation root menu 706), optional navigation links 708, silo subtree root links 710-1 to 710-N (referred to collectively as the silo subtree root links 710 or the silo subtree root menu 710), and an escape link 712. The display device 702 and the screen 704 can be implemented in a manner similar to that described above in association with the example of FIG. 6.

In the example of FIG. 7, the presentation root menu 706 includes links to presentation roots. Following a link, by selecting the link, causes a display engine to display a scene associated with the selected presentation root. The presentation roots can also optionally be reached with relative links from the optional navigation links 708. In the example of FIG. 7, the optional navigation links 708 include a “left” navigation link 714 and a “right” navigation link 716. The example presumes the presentation has an order in which “left” and “right” navigation makes sense. Relational navigation can generally be in any dimension, including time (e.g., to a previously viewed scene), or convenient conceptual framework. The “left” and “right” navigation links were chosen as an example due to their ubiquity in presentations, such as POWER POINT® presentations.

In the example of FIG. 7, the silo subtree root menu 710 includes links to child nodes of the current scene. Following a link, by selecting the link, causes a display engine to display a scene associated with the selected child node. The silo subtree root nodes can also optionally be reached with relative links (not shown). Child nodes are intended to represent drill downs into the current scene, which can be a scene associated with a presentation root node or a presentation inner node parent of the child node. Child nodes need not be unique. For example, each parent root node could include a link to an “about the presenter” scene enabling a drilldown at each scene to a common “about the presenter” scene. Child nodes may or may not include subtrees with navigation structures similar to that of a presentation root node, but within a silo of a presentation tree.

In the example of FIG. 7, the escape link 712 is intended to illustrate a mechanism for ending or pausing a presentation. For example, the escape link 712 could open an email engine to enable the presenter to send the presentation to a recipient. As another example, the escape link 712 could exit the presentation and cause a PSM selection menu to be displayed.

Not all selectable items necessarily need to be navigation selections. For example, selecting an image could cause a floating window to be displayed within the scene. Such “pop-up scenes” can be characterized as embedded scenes because they are embedded within another scene. Moreover, with some added complexity, embedded scenes could themselves have an associated navigation map that is different from the presentation or scene in which the embedded scene is embedded.

In the example of FIG. 7, the input device subsystem 718 includes an input device 720, a cursor 722 displayed on the screen 704, and button 724. The input device subsystem 718 can be implemented in a manner similar to that described above in association with the example of FIG. 6. The presentation root menu 706, optional navigation links 708, silo subtree root menu 710, and optional silo navigation links (not shown) are intended to illustrate the concept that a presentation can have a variety of navigation options. In a specific implementation, the input device subsystem 718 and the navigation options comprise a presentation navigation subsystem.

In a specific implementation, a presentation display subsystem comprising the screen 704 and the presentation navigation subsystem comprising the input device subsystem 718 and the navigation options are implemented on a mobile device, such as a tablet computer. In an alternative implementation, the presentation display subsystem is implemented on a first device, such as a device comprising a projector, and the presentation navigation subsystem is implemented on a second device, such as a tablet computer. In this alternative implementation, it may or may not be desirable to project without any visible navigation options to an audience using the first device, and include the navigation options for the presenter or agent thereof on the second device.

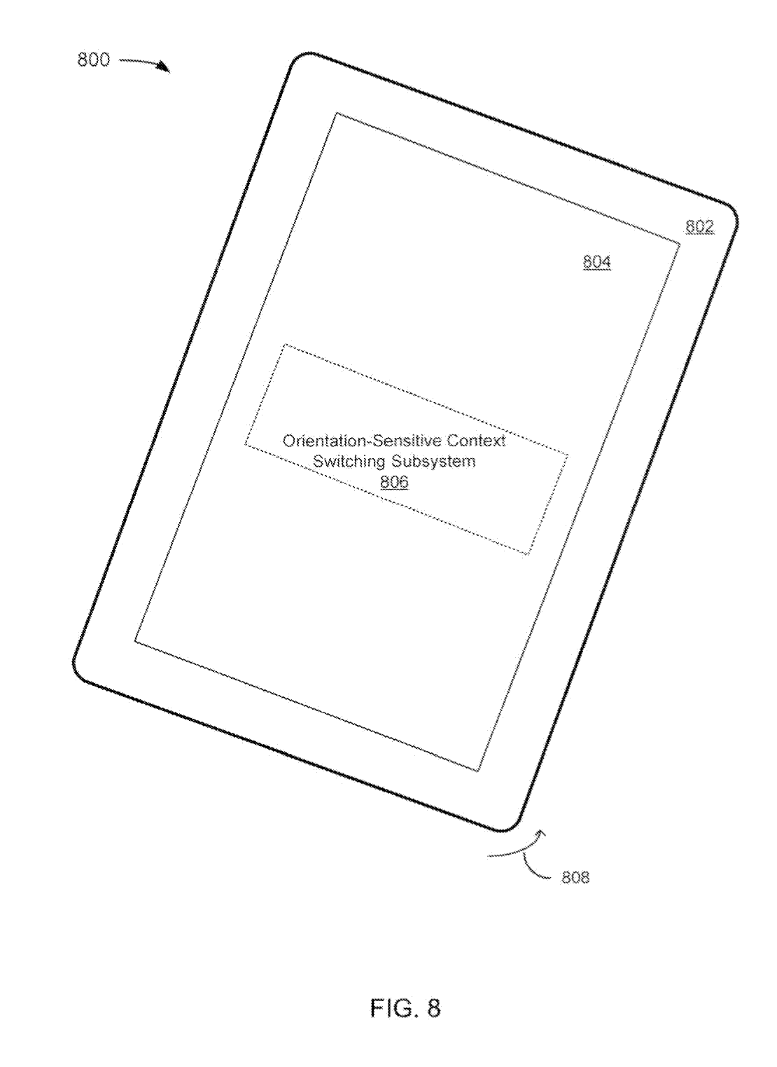

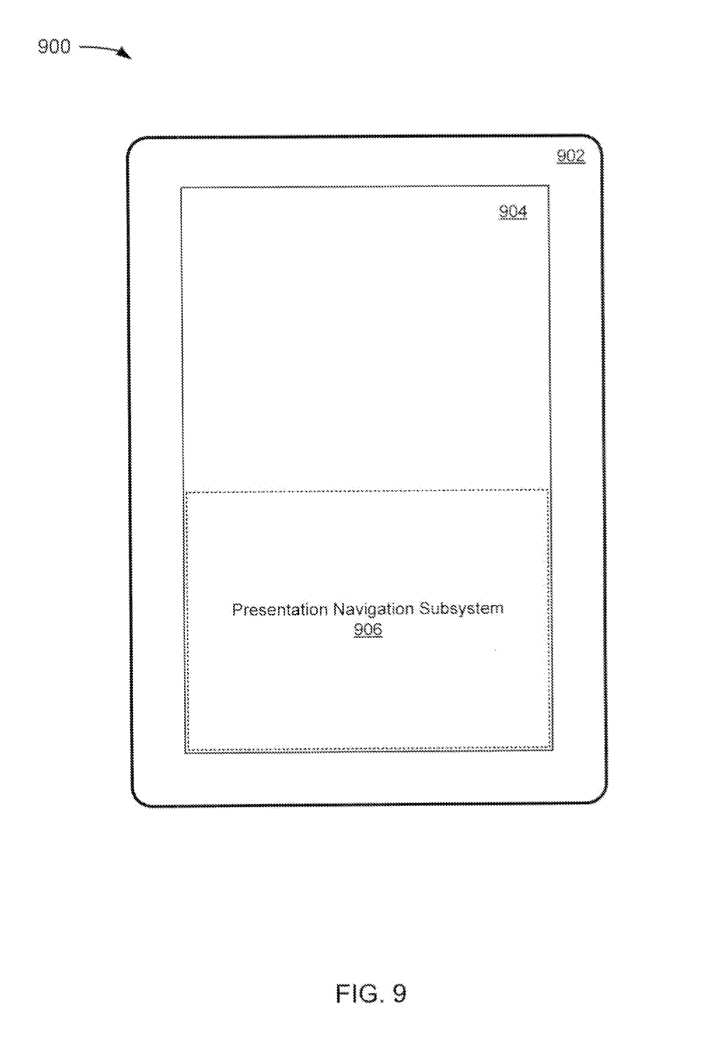

In the example of FIG. 8, the diagram 800 depicts a display device 802 with a screen 804 and an orientation-sensitive context switching subsystem 806. An arrow 808 is intended to illustrate the change of orientation of the display device 802 from a “landscape” position (see, e.g., FIG. 7) to a “portrait” position (see, e.g., FIG. 9). As is intended by the diagonal orientation of the orientation-sensitive context switching subsystem 806 in the example of FIG. 8, at least a portion of the subsystem is rotated along with the display device 802. In a specific implementation, a sensor, such as an accelerometer, of the orientation-sensitive context switching subsystem 806 detects the rotation of the display device 802 and when the sensor detects a change from a first discrete orientation to a second discrete orientation of the display device 802, the orientation-sensitive context switching subsystem 806 can inform relevant engines of the change to cause a display of an appropriate presentation given for the second discrete orientation.

When transitioning from the first discrete orientation to the second discrete orientation, the screen 804 can display the appropriate presentations. At some point, the display can be changing from a first presentation to a second presentation, and display both at the same time as the first presentation fades and the second presentation becomes prominent. In a specific implementation, the transition is impacted by the hardware features and configurations, but the transition is not associated with a defined discrete orientation. Because the number of discrete orientations is possible, the transition could have a defined discrete orientation, but, of course, the transition from the first discrete orientation to the defined discrete orientation and from the defined discrete orientation to the second discrete orientation would entail a transition, as well.

In the example of FIG. 9, the diagram 900 depicts a display device 902 with a screen 904 in a “portrait,” upright, or upside-down orientation. The display device 902 includes a presentation navigation subsystem 906, but, as discussed previously, the presentation navigation subsystem 906 can alternatively be implemented at least in part on a device that is distinct from the display device 902 (e.g., as an input device with a cursor displayed on the screen 904). For illustrative purposes, it is assumed the presentation navigation subsystem 906 is in a second discrete orientation, where a first orientation is a “landscape,” sideways, or left-side/right-side up orientation (see, e.g., FIG. 7). In a specific implementation, the scene displayed on the screen 904 is different than a corresponding scene on the screen 704 (or there is no corresponding scene) and the presentation navigation subsystem 906 is different from the presentation navigation subsystem of the display device 702 (FIG. 7).

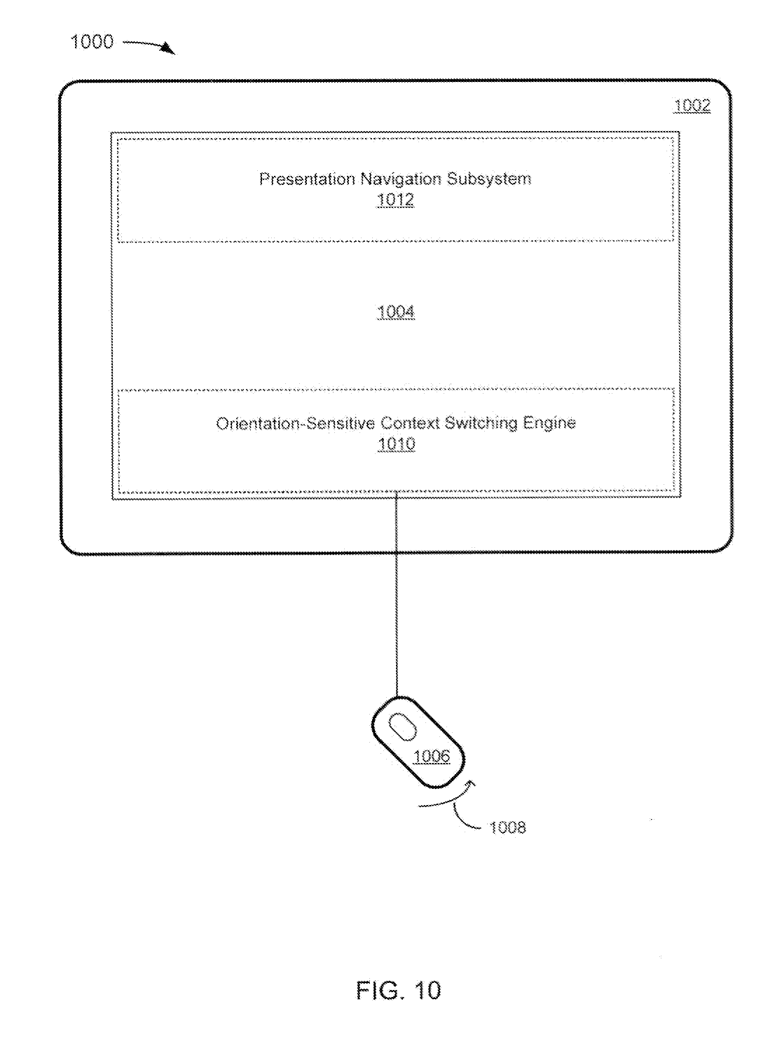

In the example of FIG. 10, the diagram 1000 depicts a display device 1002 with a screen 804 and an orientation-sensitive device 1006 coupled to the display device 1002. An arrow 1008 is intended to illustrate the change of orientation of the orientation-sensitive device 1006 from a vertical orientation to a diagonal orientation (perhaps on the way to a horizontal orientation). The arrow 1008 illustrates a counterclockwise rotation of the orientation-sensitive device, but a clockwise rotation or some other motion can be used instead. In the example of FIG. 10, the display device 1002 also includes an orientation-sensitive context switching engine 1010 and a presentation navigation subsystem 1012.

The orientation-sensitive context switching engine 1010 is coupled to the orientation-sensitive device 1006, and, in operation, when the orientation-sensitive device 1006 is moved to a discrete orientation, the orientation-sensitive context switching engine 1010 can change context on the display device 1002 such that a first presentation is switched to a second presentation. The orientation-sensitive device 1006 and the orientation-sensitive context switching engine 1010 (and potentially other engines) comprise an orientation-sensitive context switching subsystem for the display device 1002. Where another engine of the orientation-sensitive context switching subsystem is located off of the display device (e.g., on a laptop computer), the orientation-sensitive context switching engine 1010 can be implemented in a relatively simplistic manner (e.g., as an engine that receives a new context indication and switches from a first context to the new context in response thereto). Similarly, if the orientation-sensitive device 1006 is capable of determining a discrete orientation, the orientation-sensitive context switching engine 1010 can potentially be implemented in a relatively simplistic manner. In an alternative, an orientation detection sensor (not shown) can be used to determine an orientation of a device. The orientation detection sensor and the device can be characterized as an orientation-sensitive subsystem, which is conceptually a superset of the orientation-sensitive device 1006 and the orientation detection sensor plus device.

Control of the orientation-sensitive subsystem is implementation- and/or configuration-specific. For example, a change in context may be sensitive to a counterclockwise rotation of the orientation-sensitive device 1006, but not to a clockwise rotation. Such a restriction can enable a user to rotate the orientation-sensitive device 1006 to change context and then return to a “home” position without changing the context again. (In operation, the user could shift through a series of presentations with what amounts to a flick of the wrist.) Such a restriction could be modified to enable detection of a clockwise rotation from the home position in order to shift through presentations in the opposite direction.

The presentation navigation subsystem 1012 may or may not be implemented at least in part on a device that is distinct from the display device 1002 (e.g., as an input device with a cursor displayed on the screen 1004). For illustrative purposes, it is assumed the presentation navigation subsystem 1012 is associated with a second discrete orientation as determined by the orientation-sensitive context switching subsystem, where a first discrete orientation is different (see, e.g., FIG. 7). In a specific implementation, the scene displayed on the screen 1004 is different than a corresponding scene on the screen 704 (or there is no corresponding scene) and the presentation navigation subsystem 1012 is different from the presentation navigation subsystem of the display device 702 (FIG. 7).

As used in this paper, the term “display” is not intended to be limited to visual manifestations, and can include a sound “display” (such as speakers), a touch display (such as a vibrator), a temperature display (such as a heater), or any other display that can be sensed by an audience of a presentation or a presenter of the presentation.

The detailed description discloses examples and techniques, but it will be appreciated by those skilled in the relevant art that modifications, permutations, and equivalents thereof are within the scope of the teachings. It is therefore intended that the following appended claims include all such modifications, permutations, and equivalents. While certain aspects of the invention are presented below in certain claim forms, the applicant contemplates the various aspects of the invention in any number of claim forms. For example, while only one aspect of the invention is recited as a means-plus-function claim under 35 U.S.C sec. 212, sixth paragraph, other aspects may likewise be embodied as a means-plus-function claim, or in other forms, such as being embodied in a computer-readable medium. (Any claims intended to be treated under 35U.S.C. §212, ¶6 will begin with the words “means for”, but use of the term “for” in any other context is not intended to invoke treatment under 35 U.S.C. §212, ¶6.) Accordingly, the applicant reserves the right to add additional claims after filing the application to pursue such additional claim forms for other aspects of the invention.

1. A system comprising:
an orientation-sensitive context switching subsystem;
a presentation display subsystem;
a presentation navigation subsystem;
a presentation state datastore;
a presentation thread management engine coupled to the orientation-sensitive context switching subsystem, the presentation display subsystem, the presentation navigation subsystem, and the presentation state datastore;
wherein, in operation:
the orientation-sensitive context switching subsystem detects a first discrete orientation measured by an orientation-sensitive device;
the presentation display subsystem displays presentation content associated with the first discrete orientation on a presentation display device;
the presentation navigation subsystem navigates from a first navigation location to a second navigation location of the presentation content using input from a presentation navigation device;
the presentation thread management engine freezes state associated with the presentation content and the first discrete orientation in the presentation state datastore when the orientation-sensitive context switching subsystem detects a second discrete orientation of the context-sensitive device.

2. The system of claim 1, wherein the orientation-sensitive context switching subsystem further comprises a device orientation engine including:
a processor;
a sensor for supplying to the processor an orientation value sensed by the orientation-sensitive device.

3. The system of claim 2, wherein the processor determines a context-free measurement or estimate of a current orientation of the orientation-sensitive device.

4. The system of claim 2, wherein the processor determines a relative measurement or estimate of a current orientation of the orientation-sensitive device relative to a previous orientation of the context-sensitive device.

5. The system of claim 1, further comprising a discrete orientations datastore including a plurality of discrete orientations, wherein the discrete orientations are associated with a range of orientation values.

6. The system of claim 5, wherein the discrete orientations include an up orientation, a down orientation, a left orientation, and a right orientation, and wherein the discrete orientations are associated with actual discrete orientations of a mobile device, respectively held in upright, upside-down, left-side, or right-side orientations, and on which at least a portion of the orientation-sensitive context switching subsystem is implemented.

7. The system of claim 5, wherein the discrete orientations include a clockwise orientation and a counterclockwise orientation, and wherein the discrete orientations are associated with actual discrete orientations of a mobile device, respectively rotated in clockwise and counterclockwise directions, and on which at least a portion of the orientation-sensitive context switching subsystem is implemented.

8. The system of claim 1, wherein the orientation-sensitive context switching subsystem includes:
an orientation mapping datastore including a plurality of mappings of discrete orientations to a corresponding plurality of non-identical presentation content subsets;
an orientation-to-presentation mapping engine configured to use a mapping of a discrete orientation to a presentation content subset in the orientation mapping datastore to map the first discrete orientation to a first presentation content subset, wherein the presentation content displayed by the presentation display subsystem includes the first presentation content subset.

9. The system of claim 1, wherein the presentation display subsystem further comprises:
a presentation content datastore;
a plurality of presentation display engines coupled to the presentation content datastore, wherein a first presentation display engine of the plurality of presentation display engines is associated with the first discrete orientation and the first presentation display engine is configured to display a subset of the presentation content associated with the first discrete orientation.

10. The system of claim 1, wherein the presentation navigation subsystem further comprises:
a navigation map datastore;
a plurality of presentation navigation engines coupled to the navigation map datastore, wherein a first presentation navigation engine of the plurality of presentation navigation engines is associated with the first discrete orientation and the first presentation navigation engine is configured to navigate in accordance with navigation input and a first navigation map associated with the first discrete orientation.

11. A method comprising:
initiating an application;
determining an orientation-sensitive device has a first discrete orientation;
identifying a first navigation location for first presentation content associated with the first discrete orientation;
outputting the first presentation content at the first navigation location;
navigating to a second navigation location using a navigation path associated with the first discrete orientation while an orientation of the orientation-sensitive device is within an orientation range;
when current orientation falls outside the discrete orientation range:
freezing state associated with the first presentation content;
identifying a third navigation location for second presentation content associated with a second discrete orientation;
outputting the second presentation content at the third navigation location.

12. The method of claim 11, further comprising: receiving a power-on stimulus on a mobile device on which the application is implemented, wherein the application includes a presentation scene map (PSM) application.

13. The method of claim 11, further comprising: receiving an indication of a selection of a presentation scene map (PSM) responsive to a PSM selection prompt of the application.

14. The method of claim 11, further comprising: activating a first presentation associated with the first discrete orientation.

15. The method of claim 11, further comprising: activating a second presentation associated with the second discrete orientation.

16. A system comprising:
a means for initiating an application;
a means for determining an orientation-sensitive device has a first discrete orientation;
a means for identifying a first navigation location for first presentation content associated with the first discrete orientation;
a means for outputting the first presentation content at the first navigation location;
a means for navigating to a second navigation location using a navigation path associated with the first discrete orientation while an orientation of the orientation-sensitive device is within an orientation range;
when current orientation falls outside the discrete orientation range:
a means for freezing state associated with the first presentation content;
a means for identifying a third navigation location for second presentation content associated with a second discrete orientation;
a means for outputting the second presentation content at the third navigation location.

17. The system of claim 11, further comprising: a means for receiving a power-on stimulus on a mobile device on which the application is implemented, wherein the application includes a presentation scene map (PSM) application.

18. The system of claim 11, further comprising: a means for receiving an indication of a selection of a presentation scene map (PSM) responsive to a PSM selection prompt of the application.

19. The system of claim 11, further comprising: a means for activating a first presentation associated with the first discrete orientation.

20. The system of claim 11, further comprising: a means for activating a second presentation associated with the second discrete orientation.
